(19) United States
(12) Patent Application Publication
(10) Pub. No.: US 2014/0064732 A1
(43) Pub. Date: Mar. 6, 2014

(54) APPARATUS AND METHOD FOR RECEIVING OPTICAL SIGNAL, AND OPTICAL FREQUENCY-DIVISION-MULTIPLEXING TRANSMISSION SYSTEM

(71) Applicant: FUJITSU LIMITED, Kawasaki-shi (JP)

(72) Inventors: Yutaka KAI, Kawasaki (JP); Ryou OKABE, Shinagawa (JP); Tomoyuki KATO, Yokohama (JP); Shigeki WATANABE, Kawasaki (JP)

(73) Assignee: FUJITSU LIMITED, Kawasaki-shi (JP)

(21) Appl. No.: 13/934,533

(22) Filed: Jul. 3, 2013

(30) Foreign Application Priority Data
Aug. 31, 2012 (JP) 2012-192518

(51) Int. Cl. H04B 10/61; H04J 14/00

(52) U.S. Cl. CPC H04B 10/6161; H04J 14/00
USPC 398/76

(57) ABSTRACT

An optical signal receiving apparatus includes: a chromatic dispersion medium having an amount of chromatic dispersion which is determined according to a frequency of the sub-carrier modulation signals so as to receive the sub-carrier modulation signals, a photodetector configured to convert the carrier optical signal that has passed through the chromatic dispersion medium, into electrical signals, and a signal receiving unit configured to receive an electrical signal selected from the electrical signals obtained by the photodetector.

### CROSS-REFERENCE TO RELATED APPLICATION

This application is based upon and claims the benefit of priority of the prior Japanese Patent Application No. 2012-192518, filed on Aug. 31, 2012, the entire contents of which are incorporated herein by reference.

### FIELD

The embodiment discussed herein is related to an optical signal receiving apparatus, optical signal receiving method, and optical frequency-division-multiplexing transmission system that superimpose sub-carrier modulation signals on a carrier optical signal and transmit the resulting signal.

### BACKGROUND

Technologies for multiplexing optical signals having different wavelengths (optical carrier frequencies) include wavelength division multiplexing (WDM). WDM performs base-band modulation on multiple carrier optical signals having different wavelengths and multiplexes or demultiplexes the resulting signals using an optical multiplexer or demultiplexer. Accordingly, to multiplex signals at narrow wavelength (frequency) intervals, transmission apparatuses and a wavelength demultiplexer have to control the wavelength very accurately. This makes it difficult to multiplex signals at narrow wavelength (frequency) intervals.

Another such technology is optical frequency-division-multiplexing (optical FDM). In FDM, transmission apparatuses (optical multiplexing apparatuses midway through an optical transmission line) superimpose data signals having different sub-carrier frequencies on a carrier wave and multiplex the signals, whereas receiving apparatuses electrically demultiplex the signals (for example, see Japanese Laid-open Patent Publication No. 2011-215603).

Optical FDM can multiplex signals at high density, because the receiving apparatuses can demultiplex the signals using a typical narrow-band high-frequency filter. The transmission apparatuses superimpose, on a carrier optical signal, modulation signals which are superimposed on control light, by using nonlinear optical media, as well as using cross phase modulation (XPM) effects between the carrier optical signal and control light.

In optical FDM, for example, sub-carrier modulation signals phase-modulate a carrier optical signal having a single wavelength (optical frequency) using nonlinear optical media disposed midway through an optical transmission line. Thus, different data signals can be superimposed on the carrier optical signal. Since the transmission apparatuses do this with different sub-carrier frequencies, it is possible to realize frequency division multiplexing, in which the transmission apparatuses superimpose data signals on a single carrier optical signal. The receiving apparatuses can receive the data signals transmitted by the transmission apparatuses by extracting only single-sideband components of the received modulation signals using an optical filter. Since optical FDM superimposes multiple data signals on a single carrier optical signal, the receiving apparatuses only have to receive the carrier optical signal alone. For this reason, the configuration of the receiving apparatuses can be simpler than in WDM.

However, when a photodetector attempts to receive and square-law detect the carrier optical signal and sub-carrier modulation signals collectively in optical FDM, the photodetector has difficulty in receiving the sub-carrier modulation signals as they are. The reason is that when the photodetector receives both sidebands of the sub-carrier modulation signals simultaneously, data modulation components thereof are cancelled out and lost.

For this reason, in optical FDM described above, it is considered to pass the sub-carrier modulation signals through chromatic dispersion media having chromatic dispersion characteristics and then receive the signals. By passing the sub-carrier modulation signals through chromatic dispersion media, such as a single-mode optical fiber (SMF), dispersion compensation fiber (DCF), fiber Bragg grating (FBG), or Etalon filter, to add dispersion to the signals, it is possible to receive the phase-modulated signals as optical intensity signals. However, there is a physical limit to the amount of dispersion added by chromatic dispersion media. For this reason, when the amount of dispersion is less than the desirable amount, or when a too much amount of dispersion is added, the received signals become distorted, and reception strength is reduced. The optimum amount of dispersion also depends on the frequency band in which the sub-carrier modulation signals are superimposed, so as to demultiplex the base-band signals and sub-carrier modulation signals.

As seen above, in optical FDM, the amount of chromatic dispersion has to be set properly to extract the sub-carrier modulation signals as optical intensity signals. The amount of chromatic dispersion also has to correspond to chromatic dispersion characteristics of the optical transmission line or the sub-carrier frequencies of the multiple transmission apparatuses on the optical transmission line.

### SUMMARY

According to an aspect of the embodiment, an optical signal receiving apparatus includes: a chromatic dispersion medium having an amount of chromatic dispersion which is determined according to a frequency of the sub-carrier modulation signals so as to receive the sub-carrier modulation signals, a photodetector configured to convert the carrier optical signal that has passed through the chromatic dispersion medium, into electrical signals, and a signal receiving unit configured to receive an electrical signal selected from the electrical signals obtained by the photodetector.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an optical frequency-division-multiplexing transmission system according to an embodiment;

FIG. 2 illustrates an actual transmission result indicating effects of dispersion in the optical frequency-division-multiplexing transmission system;

FIG. 3 illustrates the frequency of a sub-carrier modulation signal versus the amount of chromatic dispersion which has to be added when receiving the signal, in the optical frequency-division-multiplexing transmission system;

FIG. 4 illustrates a receivable frequency bandwidth when the dispersion value is fixed;

FIG. 5 illustrates a chromatic dispersion medium disposed in a receiving apparatus;

FIG. 6 illustrates the relationships between the frequencies of sub-carrier modulation signals and the positions of nodes in the entire optical frequency-division-multiplexing transmission system;

FIG. 7 illustrates an example receiving apparatus configuration in which a fixed chromatic dispersion medium is used for each of multiple sub-carrier modulation frequencies;

FIG. 8 illustrates another example receiving apparatus configuration in which a fixed chromatic dispersion medium is used for each of multiple sub-carrier modulation frequencies;

FIG. 9 illustrates an example receiving apparatus configuration in which the frequency band of a modulation signal is determined by the system configuration;

FIG. 10 illustrates an example receiving apparatus configuration in which a variable chromatic dispersion medium is used;

FIG. 11 illustrates another example receiving apparatus configuration in which a variable chromatic dispersion medium is used;

FIG. 12 illustrates a dispersion amount variable control process performed by a monitoring control circuit illustrated in FIG. 11;

FIG. 13 illustrates another example receiving apparatus configuration in which a variable chromatic dispersion medium is used;

FIG. 14 illustrates an example of multiplexed signal management information; and

FIG. 15 illustrates a dispersion amount variable control process performed by a monitoring control unit illustrated in FIG. 13.

### DESCRIPTION OF EMBODIMENT

### Embodiment

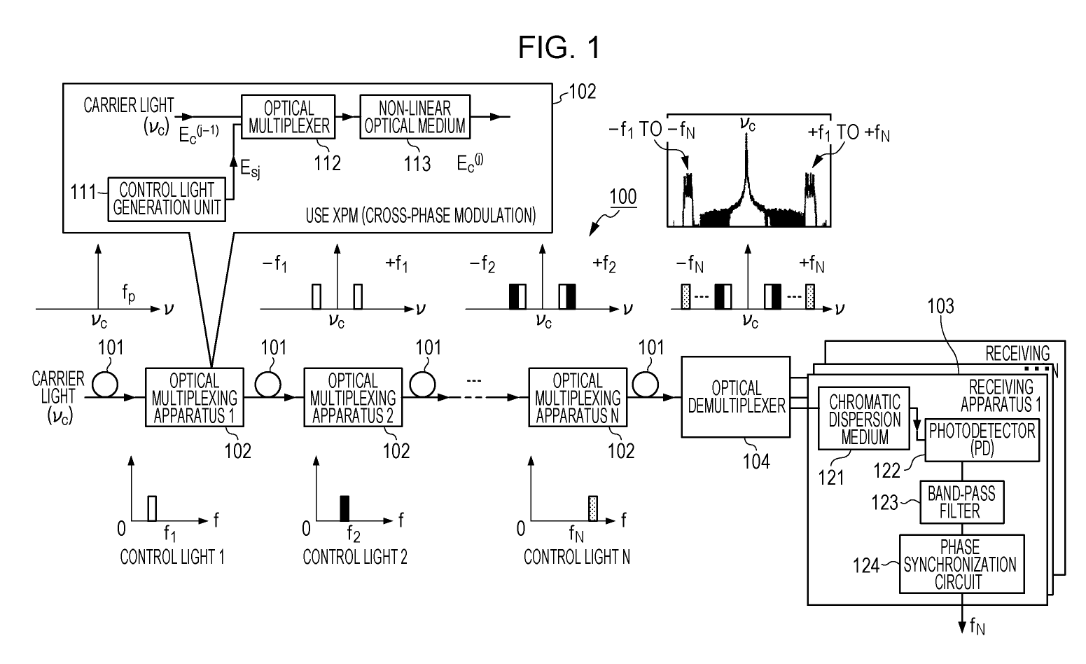

Now, a preferred embodiment of the disclosed technology will be described in detail with reference to the accompanying drawings. FIG. 1 illustrates an optical frequency-division-multiplexing transmission system according to the present embodiment.

In an optical frequency-division-multiplexing (optical FDM) transmission system 100, n number of optical multiplexing apparatuses 102 each including a nonlinear optical medium are disposed midway through an optical transmission line 101 through which carrier optical signals, such as CW light, are transmitted. The optical multiplexing apparatuses 102 superimpose n number of frequency-division-multiplexing signals on a carrier optical signal and transmit the resulting signals, whereas multiple receiving apparatuses 103 each receive the signals collectively.

The optical multiplexing apparatuses 102 disposed midway through the optical transmission line 101 each include a control light generation unit 111, an optical multiplexer 112, and a nonlinear optical medium 113. The control light generation unit 111 generates control light Eₛⱼ, which is a sub-carrier modulation signal having a sub-carrier frequency fⱼ. The sub-carrier frequency fⱼ is slightly distant from the frequency ν_{c} of the carrier optical signal. The optical multiplexer 112 multiplexes the carrier optical signal E_{c}^{(j-1)} (optical frequency ν_{c}) and the control signal Eₛⱼ generated by the control light generation unit 111. The nonlinear optical medium 113 cross-phase-modulates the carrier optical signal using the control light. In this way, the optical multiplexing apparatuses 102 superimpose the frequency-division-multiplexing signals ν_{c}±fⱼ on the carrier optical signal over a wide band.

The receiving apparatuses 103 are disposed subsequent to an optical demultiplexer 104. Each receiving apparatus 103 includes a chromatic dispersion medium 121 that adds the wavelength to a given amount of dispersion, a photodetector (PD) 122 that converts an optical signal optically received via the chromatic dispersion medium 121 into an electrical signal, and a signal receiving unit that performs an electrical reception process on the basis of the electrical signal outputted by the PD 122. The signal receiving unit includes a band-pass filter 123 that allows only a desired modulation signal to pass therethrough, a phase synchronization circuit 124 that phase-synchronizes and detects electrical signals which have transmitted through the band-pass filter, and a data processing unit that is disposed subsequent to the phase synchronization circuit 124 and performs data processing on the received signals.

The amounts of chromatic dispersion of the respective chromatic dispersion media 121 of the receiving apparatuses 103 are set to different values corresponding to the frequencies of the respective sub-carrier modulation signals of the optical multiplexing apparatuses 102 (details will be described later). Thus, the receiving apparatuses 103 can extract data modulation components from the sub-carrier modulation signals received from the optical multiplexing apparatuses 102.

In the nonlinear optical medium 113, an intensity modulation signal f_{N} superimposed on the signal light is transcribed into the carrier optical signal due to cross-phase modulation (XPM) effects and propagated. Since the optical multiplexing apparatuses 102 multiplex the signal light one after another, it is possible to achieve an ultra-wideband optical frequency-division-multiplexing transmission system which uses broadband characteristics of the nonlinear optical media 113. As illustrated in FIG. 1, the first optical multiplexing apparatus 102 on the optical transmission line 101 multiplexes modulation signals having ±f₁ relative to the carrier optical signal ν_{c} by using control light having f₁. Similarly, the second and later optical multiplexing apparatuses 102 on the optical transmission line 101 multiplex modulation signals having ±f₂, . . . , and ±f_{N}, respectively, relative to the carrier optical signal ν_{c} using control light having f₂, . . . , and f_{N}, respectively.

A sub-carrier modulation signal E(t) can be represented as in Formula (1) below.

$$E ( t ) = E exp [ i {ω}_{0} t + i {\sum }_{j = 1}^{N} {m}_{aj} ( t ) sin ( {ω}_{j} t + {m}_{pj} ( t ) + {φ}_{0 j} ) ] \qquad ( 1 )$$

In Formula (1), E represents the field amplitude; ω₀ represents the optical frequency of a carrier optical signal; ω represents the sub-carrier modulation frequency; mₐⱼ(t) represents the amplitude data modulation; mₚⱼ(t) represents the phase data modulation; and φ₀ⱼ represents the initial phase. This formula is represented as the sum of frequency components (ω₀, ω₀+ω, ω₀−ω) as in Formula (2) below by using Bessel functions.

$$E ( t ) = E [ \begin{matrix}exp ( i {ω}_{0} t ) + { \sum }_{j = 1}^{N} {J}_{1} ( {m}_{aj} ) exp ( i [ ( {ω}_{0} + {ω}_{j} ) t + {m}_{pj} + {φ}_{0 j} ] ) - \\ {\sum }_{j = 1}^{N} {J}_{1} ( {m}_{aj} ) exp ( i [ ( {ω}_{0} - {ω}_{j} ) t - {m}_{pj} - {φ}_{0 j} ] )\end{matrix} ] \qquad ( 2 )$$

J₁ is the first-order Bessel function of the first kind, and a propagation constant β is considered to be sufficiently small. Accordingly, the zero-order Bessel function J₀ is 1, and the second-order and later terms are ignored. The optical power (t)=|E(t)|² of this sub-carrier modulation signal is represented by Formula (3) below.

P(t)=E² (3)

Since β is considered to be sufficiently small, J₀=1 and J1²=0. When the photodetector (PD) 122 of the receiving apparatus 103 square-law detects the signals, data modulation component terms mₚⱼ and mₐⱼ are lost. Accordingly, when the photodetector 122 attempts to convert all frequency components of the sub-carrier modulation signals into electrical signals, the photodetector 122 has difficulty in receiving the sub-carrier modulation signals as they are. For this reason, when the receiving apparatus 103 receives the sub-carrier modulation signals, the chromatic dispersion medium 121 or birefringence medium extracts the data modulation components of the sub-carrier modulation signals as optical intensity signals. An alternative approach is to extract only single-sideband components using a steep optical filter. Among these approaches, the chromatic dispersion medium 121 is the most low-cost and easily available.

Commercially available examples of the chromatic dispersion medium 121 include typical single-mode optical fibers (SMFs) or dispersion compensation fibers (DCFs), fiber Bragg gratings (FBGs) that control the amount of dispersion, and Etalon filters. The receiving apparatus 103 can extract the data modulation components of the sub-carrier modulation signals as optical power components by using the chromatic dispersion medium 121 as described above. The field of a sub-carrier modulation signals that has passed through the chromatic dispersion medium 121 having a propagation constant 13 and a length L is represented by Formula (4) below.

E′(t)=E(t)exp(iβ(ω)L) (4)

β is the propagation constant of the chromatic dispersion medium 121. Taylor series expansion around a frequency ω₀ is represented by Formula (5) below.

β(ω)=β₀+β₁(ω−ω₀)+½β₂(ω−ω₀)² (5)

Accordingly, Formula (6) below is obtained.

$${β}_{m} = {( \frac{{d}^{m} β}{d {ω}^{m}} )}_{ω = {ω}_{0}} \qquad ( 6 )$$

Thus, different group delays are given to the terms of Formula (2) above, obtaining Formula (7) below.

$${E}^{′} ( t ) = E [ \begin{matrix}exp ( i {ω}_{0} t + i β ( {ω}_{0} ) L ) + \\ {\sum }_{j = 1}^{N} {J}_{1} ( {m}_{aj} ) exp ( i [ ( {ω}_{0} + {ω}_{j} ) t + {m}_{pj} + {φ}_{0 j} + β ( {ω}_{0} + {ω}_{j} ) L ] ) - \\ {\sum }_{j = 1}^{N} {J}_{1} ( {m}_{aj} ) exp ( i [ ( {ω}_{0} + {ω}_{j} ) t - {m}_{pj} - {φ}_{0 j} + β ( {ω}_{0} - {ω}_{j} ) L ] )\end{matrix} ] \qquad ( 7 )$$

By considering up to the second-order dispersion, Formula (8) below is obtained.

$$E ( t ) = E exp ( i {ω}_{0} t + i {β}_{0} L ) [ \begin{matrix}{1 + \sum }_{ j = 1}^{ N} {J}_{1} ( {m}_{aj} ) exp ( i [ \begin{matrix}{ω}_{j} t + {m}_{pj} + {φ}_{0 j} + \\ {β}_{1} {ω}_{j} L + \frac{1}{2} {β}_{2} {ω}_{j}^{2} L\end{matrix} ] ) - \\ {\sum }_{j = 1}^{N} {J}_{1} ( {m}_{aj} ) exp ( i [ \begin{matrix}{ω}_{j} t - {m}_{pj} - \\ {φ}_{0 {j}^{-}}^{′} - {β}_{1} {ω}_{j} L + \\ \frac{1}{2} {β}_{2} {ω}_{j}^{2} L\end{matrix} ] )\end{matrix} ] \qquad ( 8 )$$

The optical power that has passed through the chromatic dispersion medium can be obtained by Formula (9) below.

$$P ( t ) = {E}^{2} [ 1 - 4 {\sum }_{j = 1}^{N} {J}_{1} ( {m}_{aj} ) sin ( {ω}_{j} t + {m}_{pj} + {φ}_{0 j} + {β}_{1} {ω}_{j} L ) sin ( \frac{1}{2} {β}_{2} {ω}_{j}^{2} L ) ] \qquad ( 9 )$$

Thus, the data modulation components can be detected. From Formula (9), the data modulation components are maximized when sin(½·β₂ωj²L)=±1.

The optimum length of the chromatic dispersion medium 121 is represented by Formula (10) below.

$${L}_{opt} = \frac{π}{{β}_{2} {ω}_{j}^{2}} = \frac{c}{2 {λ}_{0}^{2} {f}_{j}^{2} D} \qquad ( 10 )$$

In Formula 10, λ₀ represents the center wavelength (λ₀=2π_{c}/ω₀), and D represents the amount of dispersion of chromatic dispersion (D=2πcβ₂/λ₀²).

For example, when λ₀ is 1.55 μm and the sub-carrier modulation frequency f is 6 GHz, the optimum dispersion amount D×L is 730 ps/nm. When dispersion is added using only a single-mode fiber (D=16 ps/nm/km), Lₒₚₜ=is 108 km. From Formula (9) above, Formula (11) below is used as a condition to obtain an efficiency such that the amplitude of the data modulation signal falls within −3 dB.

$$\frac{π}{6} < \frac{1}{2} {β}_{2} {ω}_{j}^{2} L < \frac{5 π}{6} \qquad ( 11 )$$

Accordingly, Formula (12) below is obtained as an optimum condition.

⅓Lₒₚₜ<L<5/3Lₒₚₜ (12)

Assuming that the amount of dispersion of the chromatic dispersion medium 121 is fixed, a frequency band satisfying the efficiency such that the amplitude of the data modulation signal falls within −3 dB is represented by Formula (13) below.

$$\sqrt{\frac{c}{6 {λ}^{2} DL}} < f < \sqrt{\frac{5 c}{6 {λ}^{2} DL}} \qquad ( 13 )$$

For example, when λ₀=1.55 μm and D×L=1730 ps/nm, 3.5 GHz<f<7.7 GHz.

As described above, the chromatic dispersion medium 121 adds appropriate dispersion; the photodetector 122 collectively receives the carrier optical signal having the multiplexed signals superimposed thereon; and then the band-pass filter (BPF) 123 electrically extracts and detects desired modulation frequencies (f₁ to f_{N}). In this way, intensity modulation signals are obtained.

The optical multiplexing apparatuses 102 are disposed on the optical transmission line 101. A signal to be multiplexed by each optical multiplexing apparatus 102 is not limited to a single sub-carrier modulation signal and may be a multiplexed signal obtained by combining independent multiple sub-carrier modulation signals.

Examples of optical cross-modulation that the optical multiplexing apparatus 102 performs using the nonlinear optical medium 113 include optical phase modulation based on cross-phase modulation and optical intensity modulation based on optical parametric effects. Examples of the nonlinear optical medium 113 include optical fibers, periodically poled lithium niobate, semiconductor optical amplifiers, and high-index contrast optical waveguides, such as a silicon wire waveguide. Examples of the optical fiber include high nonlinear optical fibers (HNLFs), as well as fiber or waveguide configurations having a nonlinear index of refraction increased by doping the core with germanium or bismuth, fiber or waveguide configurations having an optical power density increased by reducing mode field, fiber or waveguide configurations using chalcogenide glass, and photonic crystal fiber or waveguide configurations.

Other examples of the nonlinear optical medium include semiconductor optical amplifiers having a quantum well structure, quantum-dot semiconductor optical amplifiers, and silicon-photonics waveguides. Another example of the nonlinear optical medium is devices that produce second-order nonlinear optical effects, such as three wave mixing. These devices may use, for example, a LiNbO₃ waveguide having a quasi-phase-matching structure, a GaAlAs element, or second-order nonlinear optical crystal. Optionally, after performing optical cross-modulation in a second-order nonlinear optical medium, only the carrier optical signal is extracted using an optical filter, and the control light is separated.

Effects of Dispersion in Optical FDM Transmission

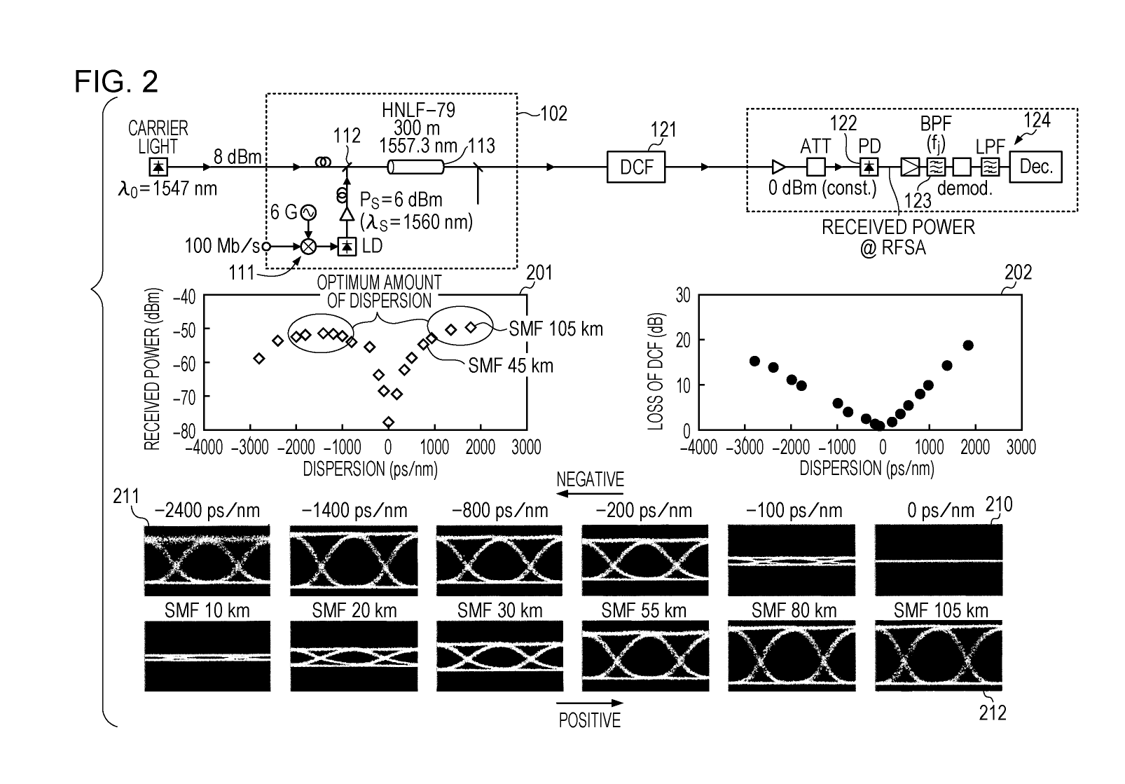

FIG. 2 is a diagram illustrating an actual transmission result indicating effects of dispersion in the optical frequency-division-multiplexing transmission system. Specifically, FIG. 2 illustrates eye patterns after the PD 122 receives the signals in the case in which the amount of dispersion added when receiving the signals is changed between −2400 ps/nm and +1800 ps/nm. The horizontal axis of Graph 201 represents the positive or negative amount of dispersion, and the vertical axis thereof represents the intensity of received light. A SMF fiber is used as the chromatic dispersion medium 121, and the amount of dispersion is changed by changing the length of the SMF fiber. To obtain the optimum amount of dispersion, the SMF fiber has to have a maximum length of 105 km or the like. The horizontal axis of Graph 202 represents the positive or negative amount of dispersion, and the vertical axis thereof represents insertion loss. This graph illustrates insertion loss when inserting the chromatic dispersion medium 121, and loss characteristics vary between the positive side and the negative side.

As illustrated in a characteristic diagram 210 of FIG. 2, when the amount of dispersion is zero, the signal is lost and therefore not receivable by the receiving apparatus 103. When an appropriate amount of dispersion is added in the negative or positive direction, the signal amplitude is increased. However, when a too much amount of dispersion is added, the signal amplitude is reduced, so that the eye pattern is stained (characteristic diagrams 211, 212, etc.). These results reveal that when receiving the signals, an appropriate amount of dispersion has to be added by the chromatic dispersion medium 121. Specifically, since the receiving apparatus 103 collectively receives phase-modulated, both sidebands of modulation signals and then square-law detects the desired modulation signal using the photodetector 122, it has to add an appropriate amount of dispersion to the modulation signals. These results also reveal that the same amount of dispersion gives the same reception strength in any of the positive and negative directions.

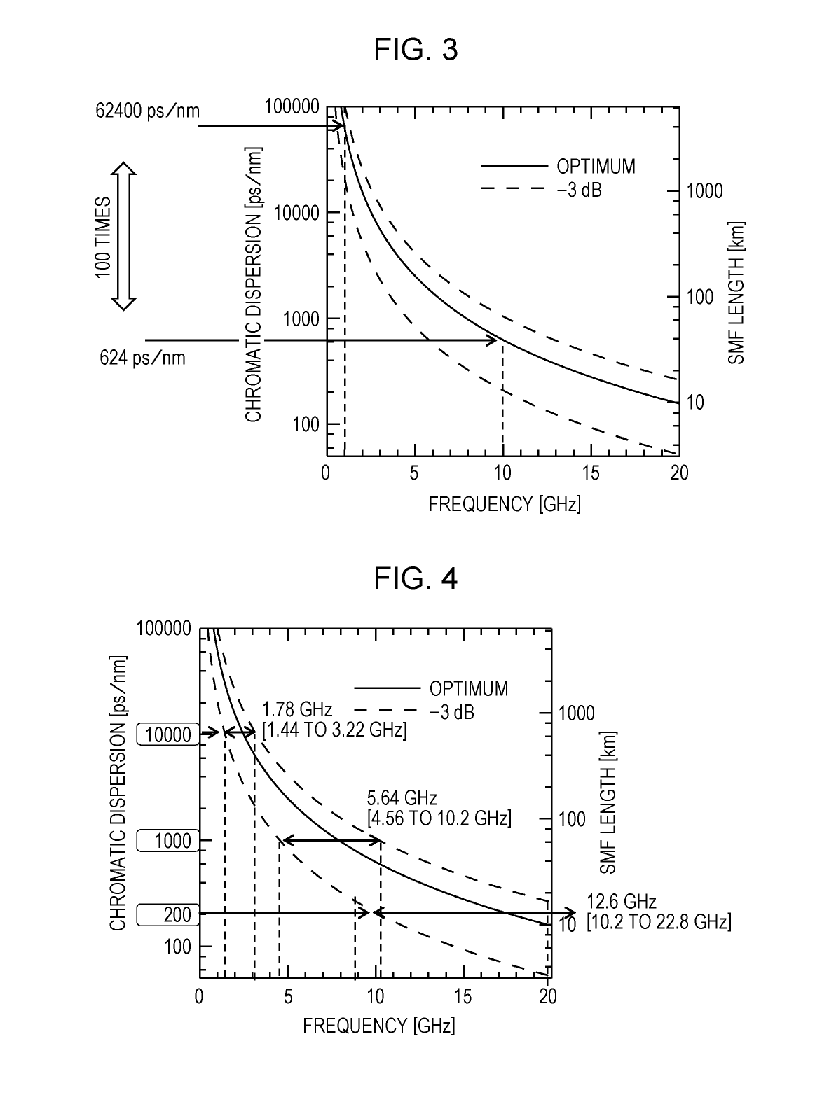

FIG. 3 is a graph illustrating the frequency of a sub-carrier modulation signal versus the amount of chromatic dispersion which has to be added when receiving the signal, in the optical frequency-division-multiplexing transmission system. The horizontal axis represents the frequency, and the vertical axes represent the optimum amount of dispersion and the length of a SMF serving as the chromatic dispersion medium 121, respectively. The amount of chromatic dispersion Dₒₚₜ which has to be added when the receiving apparatus 103 receives the sub-carrier modulation signal is represented by Formula (14) below and is inversely proportional to the square of the frequency of the sub-carrier modulation signal.

$${D}_{opt} = \frac{c}{2 {λ}_{0}^{2} {f}_{j}^{2}} \qquad ( 14 )$$

For example, the amount of chromatic dispersion when receiving a sub-carrier frequency of 1 GHz is 62400 ps/nm. Such an amount of chromatic dispersion is difficult to obtain using a SMF. In contrast, the amount of chromatic dispersion when receiving a sub-carrier frequency of 10 GHz is 624 ps/nm. As seen above, the amount of dispersion desirable for the latter signal having a ten-times higher frequency than the former is one-hundredth of that of the former. When the received sub-carrier signal has a lower frequency, a much greater amount of chromatic dispersion has to be added disadvantageously. In contrast, when the sub-carrier signal has a higher frequency, a smaller amount of chromatic dispersion is added. However, the cost of the optical component or electric component is increased. Accordingly, it is desirable to set an appropriate operating frequency range in terms of chromatic dispersion.

FIG. 4 is a graph illustrating a receivable frequency bandwidth when the dispersion value is fixed. The horizontal axis represents frequency, and the vertical axes represent the optimum amount of dispersion and the length of a SMF serving as the chromatic dispersion medium 121, respectively. This graph illustrates a frequency range having a maximum of signal amplitude of ±3 dB. As illustrated in FIG. 4, when the chromatic dispersion medium 121 has an amount of chromatic dispersion of 200 ps/nm, it can receive sub-carrier modulation signals in a bandwidth of 12.6 GHz [10.2 to 22.8 GHz]. When the chromatic dispersion medium 121 has an amount of chromatic dispersion of 1000 ps/nm, it can receive sub-carrier modulation signals in a bandwidth of 5.64 GHz [4.56 to 10.2 GHz]. When the chromatic dispersion medium 121 has an amount of chromatic dispersion of 10000 ps/nm, it can receive sub-carrier modulation signals in a bandwidth of 1.78 GHz [1.44 to 3.22 GHz]. As seen above, if there is disposed a single chromatic dispersion medium 121 having a fixed amount of chromatic dispersion, the chromatic dispersion medium 121 has difficulty in receiving all sub-carrier modulation signals, and there is a limit to the frequency range over which the receiving apparatus 103 can receive sub-carrier modulation signals.

Chromatic Dispersion Medium Disposed in Receiving Apparatus

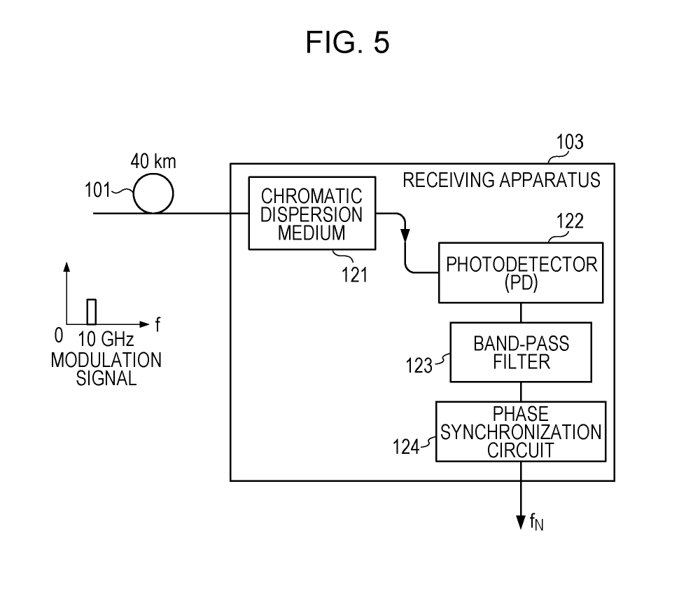

FIG. 5 is a diagram illustrating the chromatic dispersion medium disposed in the receiving apparatus. For the chromatic dispersion medium 121 disposed in the receiving apparatus 103, use of a chromatic dispersion medium which adds positive dispersion advantageously allows the entire cost to be reduced. As illustrated in FIG. 2, the amount of chromatic dispersion Dₒₚₜ which has to be added when receiving a sub-carrier modulation signal may be a positive or negative amount. Where a typical single-mode fiber (SMF) is used as the optical transmission line 101, dispersion is positive (when a carrier optical signal in a 1.55-μm band is used, about 16 ps/nm/km).

For example, as illustrated in FIG. 5, it is assumed that the receiving apparatus 103 receives a 10-GHz sub-carrier modulation signal that has been transmitted over 40 km. When the wavelength of the carrier optical signal is 1.55 μm, it is dispersed at 16 ps/nm/km by the SMF serving as the optical transmission line 101, therefore, by a total amount of dispersion of 16×40=640 ps/nm. Further, FIGS. 3 and 4 indicate that the amount of dispersion which has to be added when receiving a 10-GHz signal is about 624 ps/nm (when 200 to 1040 ps/nm, an amplitude of ±3 dB). That is, in the case that the receiving apparatus 103 receives a positively dispersed signal, if the optical transmission line 101 has the function of the chromatic dispersion medium 121, the receiving apparatus 103 does not have to include the chromatic dispersion medium 121. On the other hand, in the case where the receiving apparatus 103 receives a negatively dispersed signal, the receiving apparatus 103 has to include the chromatic dispersion medium 121 having an amount of dispersion of −640−624=−1264 ps/nm (when −860 to −1680 ps/nm, an amplitude of ±3 dB) to achieve −624 ps/nm in combination with that of the optical transmission line 101.

Generally, a commercially available chromatic dispersion medium 121 having a greater amount of dispersion is more costly. Accordingly, use of the optical transmission line 101 as a positive chromatic dispersion medium can reduce cost compared to use of a negative chromatic dispersion medium.

Frequencies of Sub-Carrier Modulation Signals and Positions of Nodes in Optical FDM Transmission

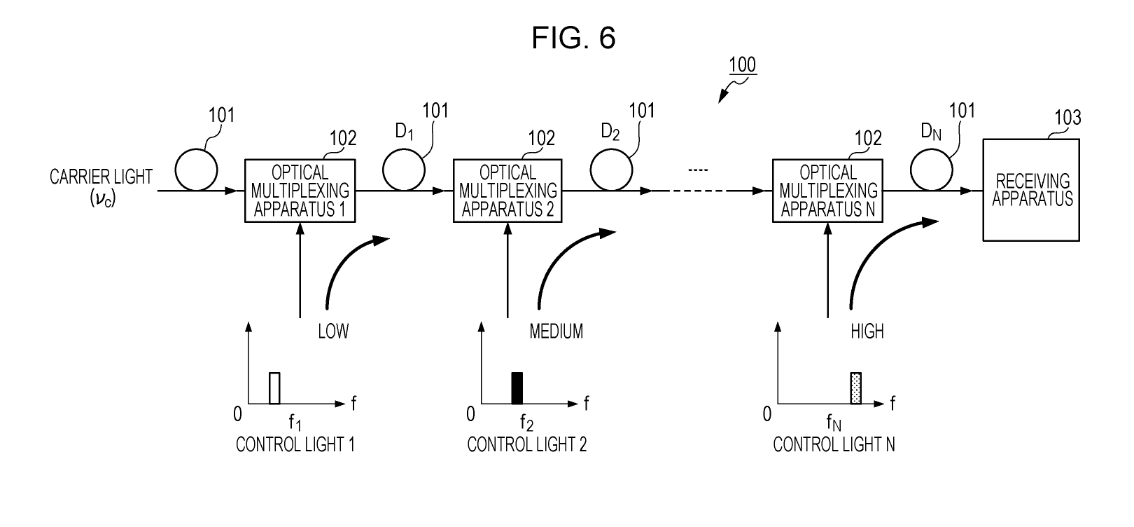

FIG. 6 is a diagram illustrating the relationships between the frequencies of sub-carrier modulation signals and the positions of nodes in the entire optical frequency-division-multiplexing transmission system. The graphs of the frequency versus the amount of dispersion of a modulation signal illustrated in FIGS. 3 and 4 reveal that when the receiving apparatus 103 receives a signal having a lower frequency, it has to add a greater amount of chromatic dispersion to the signal. Where the optical transmission line 101 adds dispersion, a greater amount of chromatic dispersion accumulates as the length of the optical transmission line 101 is longer.

For example, the amount of dispersion that a modulation signal f₁ receives from the optical transmission line 101 is D₁+D₂+ . . . D_{N}; the amount of dispersion that a modulation signal f₂ receives from the optical transmission line 101 is D₂+ . . . D_{N}; and the amount of dispersion that a modulation signal f_{N} receives from the optical transmission line 101 is D_{N}. Accordingly, the amount of dispersion that a modulation signal k receives from the optical transmission line 101 is represented by Formula (15) below.

Amount of dispersion that modulation signal k receives from optical transmission line

$$101 = {\sum }_{i = 1}^{N} {D}_{i} - {\sum }_{i = 1}^{k - 1} {D}_{i} \qquad ( 15 )$$

where N represents the number of optical multiplexing apparatuses, that is, the number of the optical multiplexing apparatuses 1 and later.

Accordingly, a sub-carrier modulation signal having a lower frequency is allocated to an optical multiplexing apparatus 102 which is more distant from the receiving side (receiving apparatus 103) (in the example illustrated in FIG. 6, an optical multiplexing apparatus 1 or an optical multiplexing apparatus closer to the optical multiplexing apparatus 1). Thus, the amount of dispersion that the chromatic dispersion medium 121 has to add can be reduced compared to when a sub-carrier modulation signal having a lower frequency is allocated to an optical multiplexing apparatus 102 which is closer to the receiving side. As a result, the cost of the chromatic dispersion media in the entire optical FDM system can be reduced advantageously.

First Example Receiving Apparatus Configuration Corresponding to Multiple Sub-Carrier Modulation Bands

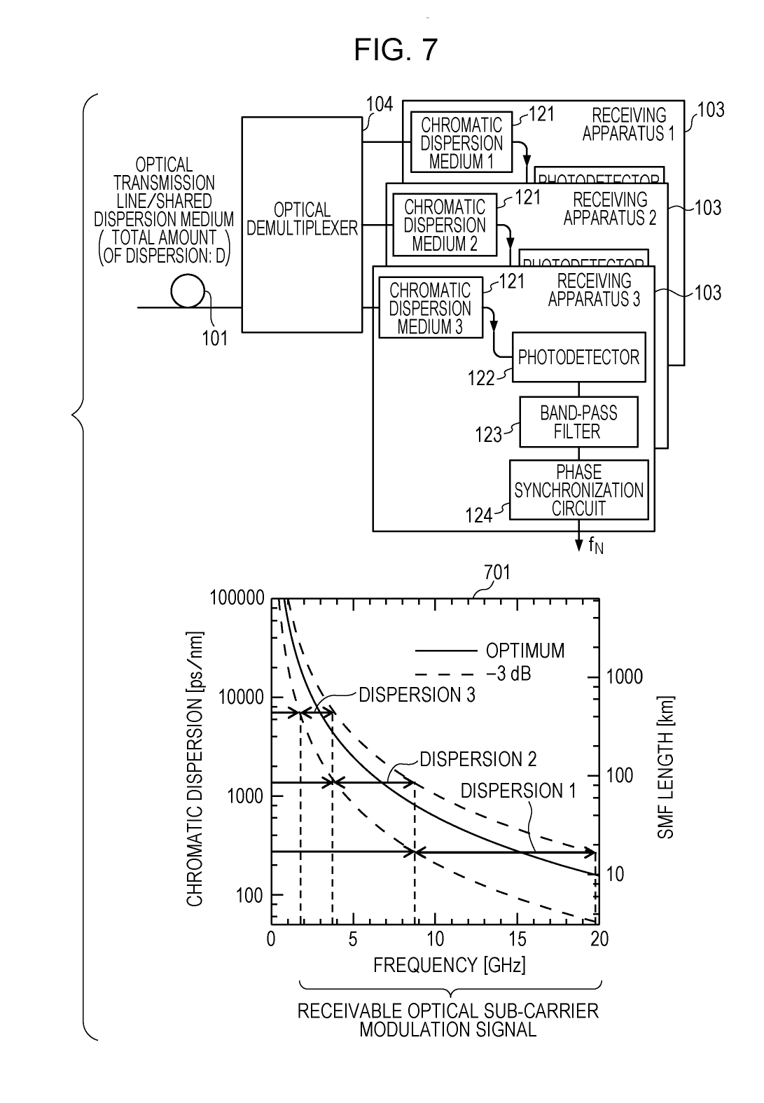

FIG. 7 is a diagram illustrating an example receiving apparatus configuration in which a fixed chromatic dispersion medium is used for each of multiple sub-carrier modulation frequencies. Multiple sub-carrier modulation signals are multiplexed in the optical transmission line 101. If it is difficult to collectively receive the sub-carrier modulation signals in view of the amount of dispersion, there are prepared multiple receiving apparatuses 103 corresponding to the bands in which the sub-carrier modulation signals are received. Disposed as a stage preceding the multiple receiving apparatuses 103 is an optical demultiplexer 104 for branching light into the receiving apparatuses 103, such as a coupler.

FIG. 7 illustrates an example in which chromatic dispersion media 1 to 3 having different amounts of dispersion are used. In this example, there are disposed three receiving apparatuses: a receiving apparatus 1 (103) for 1.8 to 4 GHz, a receiving apparatus 2 (103) for 4 to 9 GHz, and a receiving apparatus 3 (103) for 9 to 20 GHz. The optical transmission line 101 is commonly used as a chromatic dispersion medium common to these bands. The chromatic dispersion media 1 to 3 provide amounts of dispersion obtained by subtracting the amount of dispersion of the optical transmission line 101 from the desired amounts of dispersion.

For example, referring to Graph 701 of FIG. 7, amount of dispersion of dispersion medium 1=amount of dispersion 1 of FIG. 7−amount of dispersion D1 of optical transmission line 101; amount of dispersion of dispersion medium 2=amount of dispersion 2 of FIG. 7−amount of dispersion D2 of the optical transmission line 101; and amount of dispersion of dispersion medium 3=amount of dispersion 3 of FIG. 7−amount of dispersion D3 of optical transmission line 101.

The amounts of dispersion of the receiving apparatuses 1 to 3 are set to amounts of dispersion corresponding to different frequency bands in which the receiving apparatus 1 to 3 (103) can receive signals. For example, the amounts of dispersion of the receiving apparatuses 1 to 3 are set to amounts of dispersion such that the frequency bands do not overlap each other relative to a ±3 dB amplitude illustrated in Graph 701. Alternatively, parts of the frequency bands (the edges of the frequency bands) may overlap each other. Thus, modulation signals in a wide frequency band of 1.8 G to 20 G can be received by the three receiving apparatuses, 1 to 3 (103), which use the chromatic dispersion media 1 to 3 (121) having different amounts of dispersion.

Second Example Receiving Apparatus Configuration Corresponding to Multiple Sub-Carrier Modulation Bands

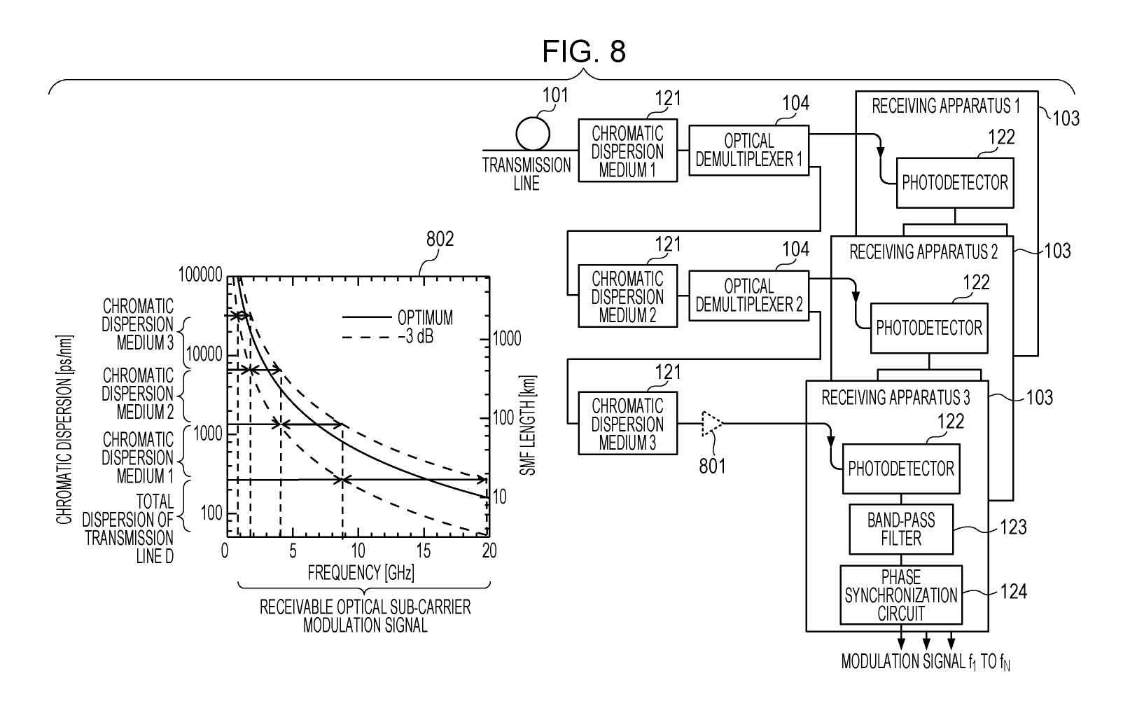

FIG. 8 is a diagram illustrating another example receiving apparatus configuration in which a fixed chromatic dispersion medium is used for each of multiple sub-carrier modulation frequencies. While the chromatic dispersion media 121 corresponding to the frequency bands are used in the first example configuration (see FIG. 7), the chromatic dispersion media 121 are cascade-connected in a second example configuration illustrated in FIG. 8. The receiving apparatus 1 receives a modulation signal that has passed through the chromatic dispersion medium 1 (121), via an optical demultiplexer 1 (104). The receiving apparatus 2 receives a modulation signal that has passed through the optical demultiplexer 1 (104) and the chromatic dispersion medium 2 (121), via an optical demultiplexer 2 (104). The receiving apparatus 3 receives a modulation signal that has passed through the optical demultiplexer 2 (104) and the chromatic dispersion medium 3 (121). Where a large number of chromatic dispersion media are cascade-connected, an optical amplifier 801 may be disposed.

Referring to Graph 802, the receiving apparatuses 1 to 3 (103) add the following amounts of dispersion to the signals received thereby: for receiving apparatus 1, amount of dispersion D of optical transmission line 101+amount of dispersion of chromatic dispersion medium 1; for receiving apparatus 2, amount of dispersion D of optical transmission line 101+amount of dispersion of chromatic dispersion medium 1+amount of dispersion of chromatic dispersion medium 2; and for receiving apparatus 3, amount of dispersion D of optical transmission line 101+amount of dispersion of chromatic dispersion medium 1+amount of dispersion of chromatic dispersion medium 2+amount of dispersion of chromatic dispersion medium 3.

As a result, an increase in the number of receiving apparatuses 103 increases the number of cascaded-connected chromatic dispersion media 121 and thus degrades reception sensitivity accordingly. On the other hand, the amount of dispersion of each chromatic dispersion medium 121 can be reduced advantageously. Even when amounts of chromatic dispersion desirable for the frequency bands are allocated to the receiving apparatuses 103 in accordance with the configurations of the receiving apparatuses 103 on the basis of formulas for desired amounts of dispersion, it is possible to receive modulation signals in multiple sub-carrier modulation bands.

Third Example Receiving Apparatus Configuration Corresponding to Multiple Sub-Carrier Modulation Bands

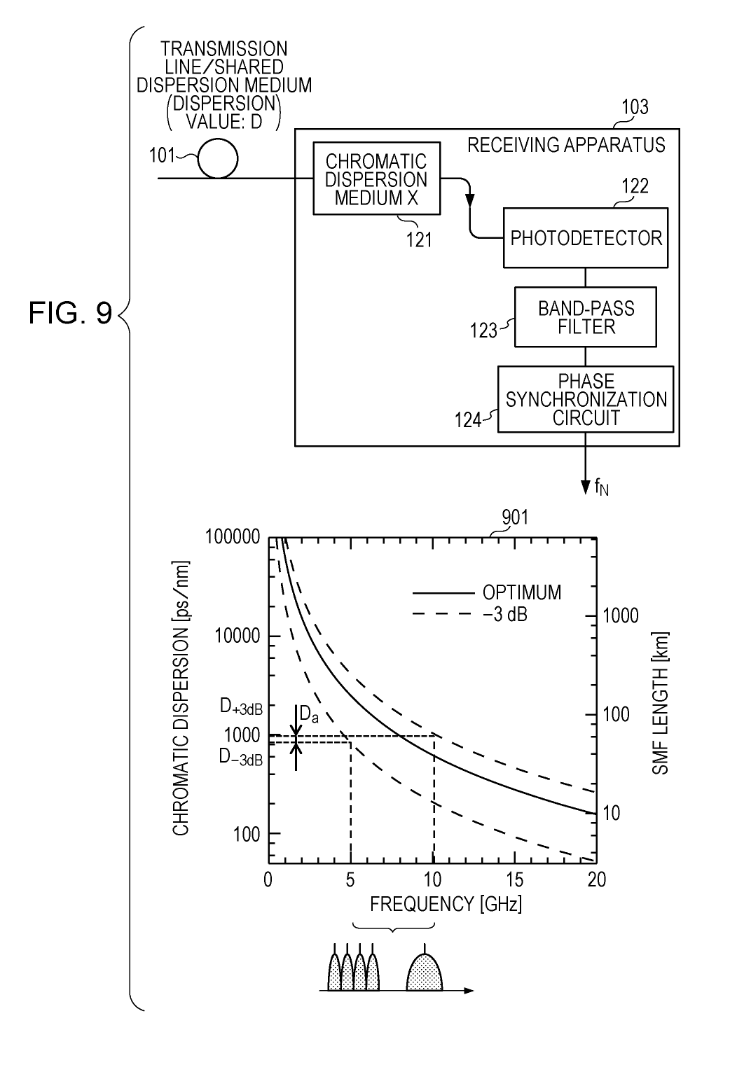

FIG. 9 is a diagram illustrating an example receiving apparatus configuration in which the frequency band of modulation signals is determined by the system configuration. In a configuration where the entire system uses only a particular frequency band, the amount of dispersion is set to a value that satisfies the following conditional expression: amount of dispersion D_{-3dB} at lower limit frequency of operating frequency band<amount of dispersion of chromatic dispersion medium X (121)+amount of dispersion D of optical transmission line 101<amount of dispersion D_{+3dB} at upper limit frequency of operating frequency band. More specifically, the amount of dispersion is represented by Formula (16) below.

$$\frac{1}{3} \times \frac{c}{2 {λ}_{0}^{2} {f}_{Low}^{2}} \leq \qquad$$

amount of dispersion of dispersion medium X+amount of dispersion D of transmission line<D_{+3dB} . . . (16) where f_{Low} represents the lower limit frequency of the operating frequency band, and f_{High} represents the upper limit frequency of the operating frequency band.

For example, as illustrated in Graph 901, when the entire operating band of modulation signals is 5 to 10 GHz, a chromatic dispersion medium X (121) is disposed such that the sum of the amounts of dispersion of the chromatic dispersion medium X and the optical transmission line 101 is a total amount of dispersion Dₐ.

Failure to satisfy the conditional expression means that a single fixed chromatic dispersion medium has difficulty in receiving signals in the operating frequency band. In this case, as illustrated in FIGS. 7 and 8, it is desirable to divide the operating frequency band and receive signals in the divided bands, or to review the operating frequency band to change it to a narrower band.

Fourth Example Receiving Apparatus Configuration Corresponding to Multiple Sub-Carrier Modulation Bands

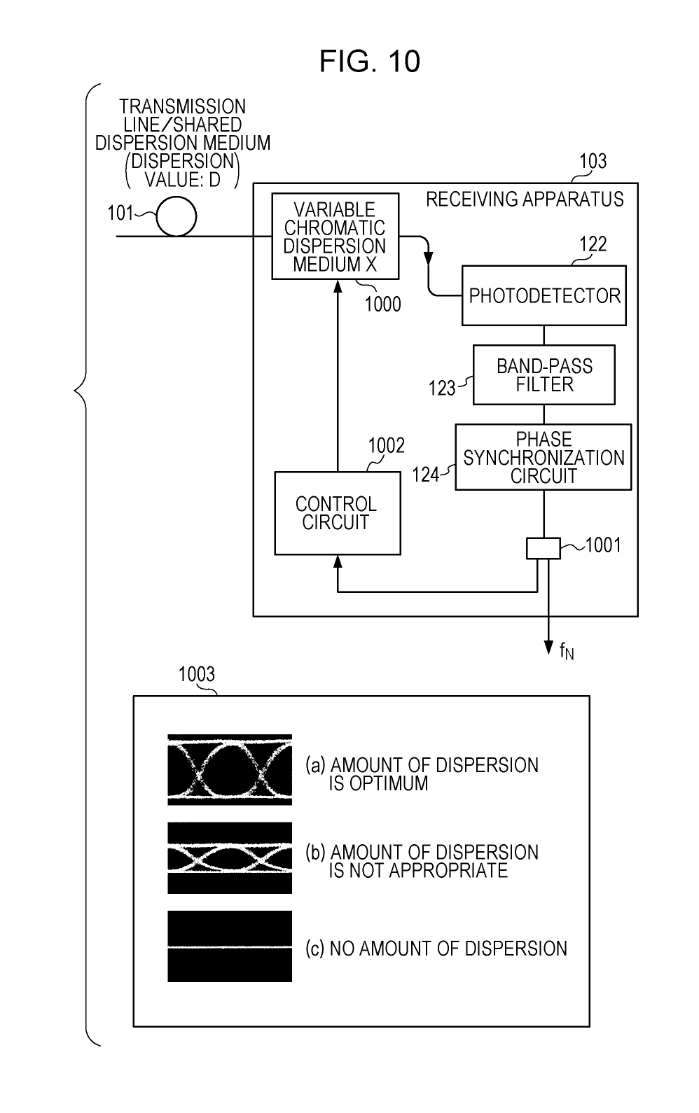

FIG. 10 is a diagram illustrating an example receiving apparatus configuration in which a variable chromatic dispersion medium is used. As described above, optimization of the amount of dispersion maximizes the signal amplitude (see FIG. 2). For example, Diagram 1003 illustrates conceivable states of the signal amplitude: (a) the amount of dispersion is optimum; (b) the amount of dispersion is not appropriate; and (c) no amount of dispersion. For this reason, the receiving apparatus 103 monitors the amplitude of the received modulation signal using a control circuit 1002. Disposed subsequent to the phase synchronization circuit 124 is an electrical branch coupler 1001 which branches the received modulation signal into an electrical receiving unit and the control circuit 1002.

The control circuit 1002 variably controls the amount of dispersion of a variable chromatic dispersion medium X (1000) so that the monitored signal amplitude is maximized. Conceivable configurations of the variable chromatic dispersion medium X (1000) include a configuration in which the amount of dispersion is changed by changing the temperature using an FBG or etalon and a configuration in which the amount of dispersion is electrically changed using a virtually imaged phased array (VIPA). The only thing to do in this case is to variably control the amount of dispersion of the variable chromatic dispersion medium X (1000) so that the monitored signal amplitude is maximized. Accordingly, an eye pattern open state as illustrated in Diagram 1003 does not have to be detected. By variably controlling the amount of dispersion of the variable chromatic dispersion medium X (1000) using the variable chromatic dispersion medium X (1000) so that the monitored signal amplitude is maximized, the amount of dispersion is kept optimum, as illustrated in (a) of Diagram 1003.

Fifth Example Receiving Apparatus Configuration Corresponding to Multiple Sub-Carrier Modulation Bands

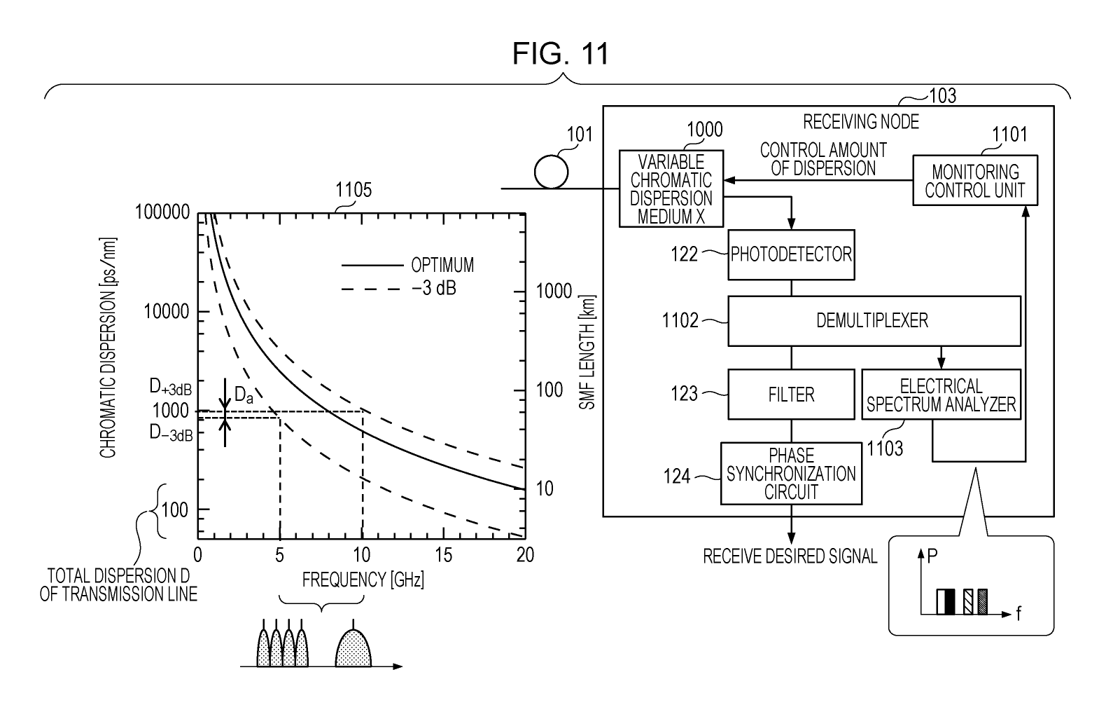

FIG. 11 is a diagram illustrating another example receiving apparatus configuration in which a variable chromatic dispersion medium is used. As with FIG. 10, FIG. 11 illustrates a configuration in which the variable chromatic dispersion medium X (1000) is used. However, in FIG. 11, rather than monitoring the signal amplitude, the electrical spectrum of a modulation signal received by the photodetector 122 is monitored using an electrical spectrum analyzer 1103.

To dispose the electrical spectrum analyzer 1103, a demultiplexer 1102 is disposed subsequent to the photodetector (PD) 122. The demultiplexer 1102 branches a modulation signal to the filter (low-pass filter) 123 and the electrical spectrum analyzer 1103. The electrical spectrum analyzer 1103 produces a monitor output and transmits it to a monitoring control circuit 1101. Based on the monitor output transmitted by the electrical spectrum analyzer 1103, the monitoring control circuit 1101 controls the amount of dispersion added by the variable chromatic dispersion medium X (1000).

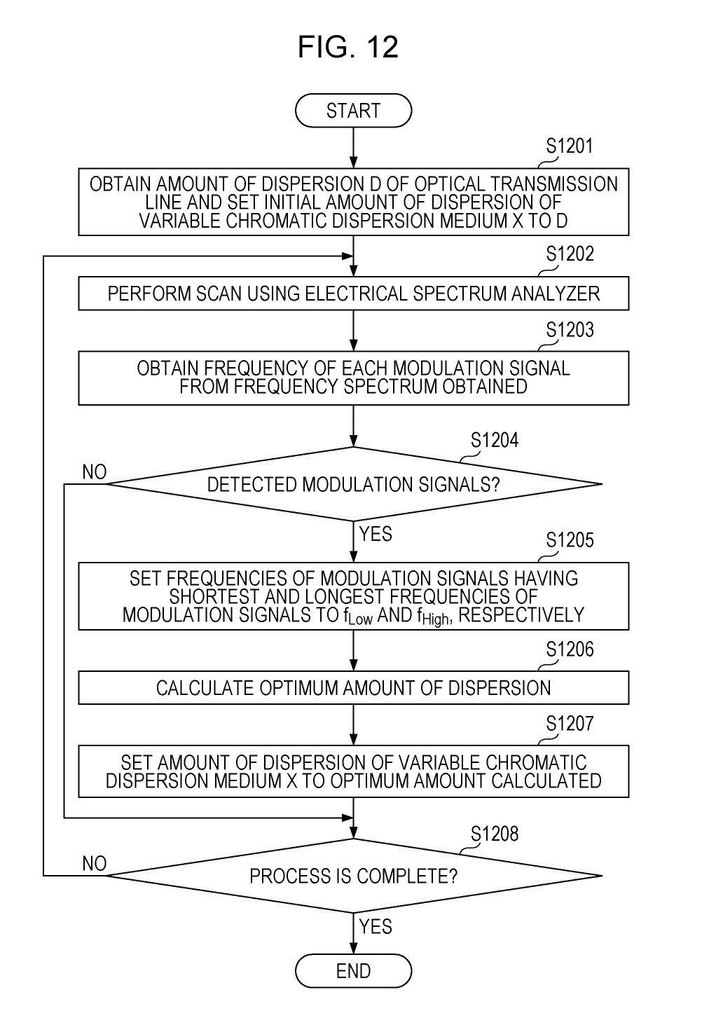

FIG. 12 is a flowchart illustrating a dispersion amount variable control process performed by the monitoring control circuit illustrated in FIG. 11. First, the monitoring control circuit 1101 obtains the amount of dispersion D of the optical transmission line 101 and sets the initial amount of dispersion of the variable chromatic dispersion medium X (1000) to the amount of dispersion D (operation S1201). The monitoring control circuit 1101 then causes the electrical spectrum analyzer 1003 to perform a scan (operation S1202). Specifically, the monitoring control circuit 1101 causes the electrical spectrum analyzer 1103 to obtain a frequency spectrum in a given frequency range.

The monitoring control circuit 1101 then obtains the frequencies of modulation signals from the frequency spectrum obtained (operation S1203). The monitoring control circuit 1101 then determines whether modulation signals have been detected (signals have been received by the receiving node) (operation S1204). If modulation signal have been detected (operation S1204: YES), the monitoring control circuit 1101 proceeds to operation S1205; if no modulation signals have been detected (operation S1204: NO), it proceeds to operation S1208.

In operation S1205, the monitoring control circuit 1101 identifies modulation signals having the lowest and highest frequencies in the modulation signals detected and sets these frequencies to f_{LOW} and f_{High}, respectively. The monitoring control circuit 1101 then calculates the optimum amount of dispersion using Formula (16) above (operation S1206). The monitoring control circuit 1101 then sets the amount of dispersion of the variable chromatic dispersion medium X (1000) to the optimum amount of dispersion calculated (operation S1207). The monitoring control circuit 1101 then determines whether the process is complete (operation S1208). If a scan has to be performed (operation S1208: NO), the monitoring control circuit 1101 returns to operation S1202; if a scan is complete (operation S1208: YES), it ends the process.

For example, as illustrated in Diagram 1105 of FIG. 11, when the entire operating band of modulation signals is 5 to 10 GHz, the total amount of dispersion (including the amount of dispersion of the optical transmission line 101) lies between D_{-3dB}, i.e. 831.9 ps/nm and D_{+3dB}, i.e. 1039.8 ps/nm (Dₐ in Diagram 1105). By subtracting the amount of dispersion of the optical transmission line 101 from this amount, the amount of dispersion of the variable chromatic dispersion medium X (1000) is calculated.

While the configuration illustrated in FIG. 10 mentioned earlier can optimize the amount of dispersion with respect to each modulation signal, that configuration has difficulty in controlling the amounts of dispersion collectively with respect to multiple modulation signals. On the other hand, the configuration illustrated in FIG. 11 can identify multiple modulation signals by using the electrical spectrum analyzer 1103. Thus, it is possible to set the amounts of dispersion which are optimum for the entire operating band of the system.

Sixth Example Receiving Apparatus Configuration Corresponding to Multiple Sub-Carrier Modulation Bands

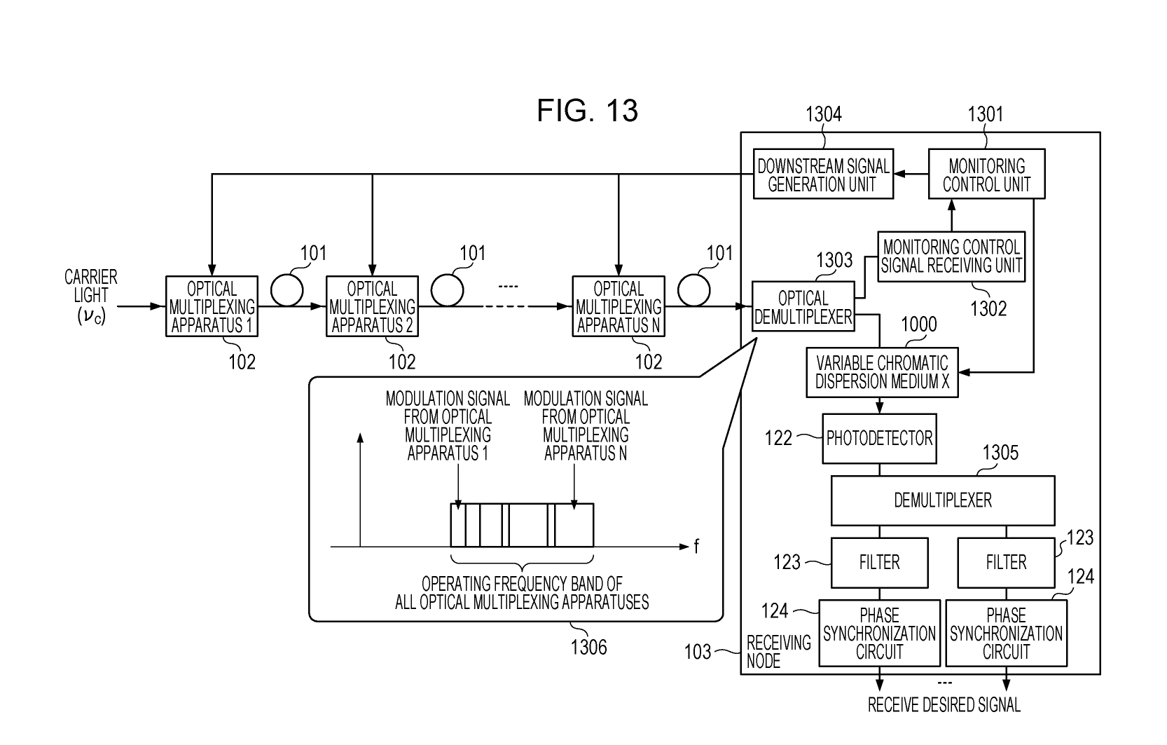

FIG. 13 is a diagram illustrating yet another example receiving apparatus configuration in which a variable chromatic dispersion medium is used. As with the example configuration described above, this configuration uses the variable chromatic dispersion medium X (1000). The receiving apparatus 103 manages multiple optical multiplexing apparatuses 1 to N (102) using multiplexed signal management information. The multiplexed signal management information is used to centrally manage the operating frequency band of the entire system to realize high-density frequency-division-multiplexing.

For this reason, in addition to the components illustrated in FIG. 10, the receiving node (receiving apparatus 103) includes a monitoring control unit 1301, a monitoring control signal receiving unit 1302, an optical demultiplexer 1303, a downlink signal generation unit 1304, and a demultiplexer 1305. Disposed subsequent to the demultiplexer 1305 are filters 123 having different passbands and multiple phase synchronization circuits 124 that correspond to multiple modulation signals having different frequencies.

The optical demultiplexer 1303 branches a modulation signal received from the optical transmission line 101 to the variable chromatic dispersion medium X (1000) and the monitoring control signal receiving unit 1302. As illustrated in Diagram 1306, the optical demultiplexer 1303 branches and outputs multiplexed signal management information transmitted by the optical multiplexing apparatuses 1 to N (102) to the monitoring control signal receiving unit 1302. The monitoring control signal receiving unit 1302 receives the multiplexed signal management information transmitted by the optical multiplexing apparatuses 1 to N (102) and outputs it to the monitoring control unit 1301. The monitoring control unit 1301 centrally manages the operating frequency band of the entire system on the basis of the multiplexed signal management information received by the monitoring control signal receiving unit 1302, as well as information, such as the output states of modulation signals of the optical multiplexing apparatuses 1 to N (102). The monitoring control unit 1301 then identifies the operating frequency band of all the optical multiplexing apparatus 102 and sets the amount of dispersion of the variable chromatic dispersion medium X (1000) to the optimum amount. As illustrated in diagram 1306 of FIG. 13, the operating frequency band of the optical multiplexing apparatuses 1 to N (102) includes modulation frequencies and an occupied bandwidth corresponding to the modulation frequencies.

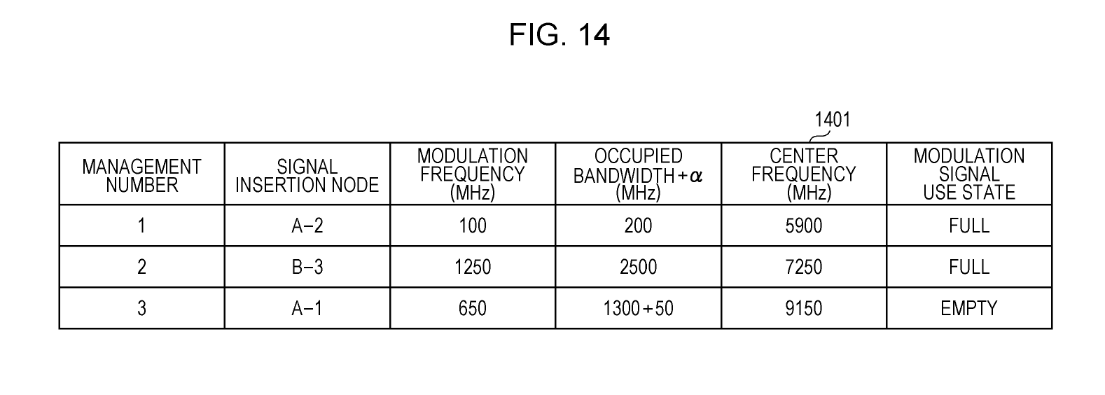

FIG. 14 is a diagram illustrating an example of the multiplexed signal management information. Multiplexed signal management information 1401 is outputted by each of the optical multiplexing apparatuses 1 to N (102), and then given management numbers and managed in a management table (not illustrated) by the monitoring control unit 1301. The multiplexed signal management information 1401 includes parameters: management number, signal insertion node, modulation frequency, occupied bandwidth, center frequency, and modulation signal use state (empty or full). The downlink signal generation unit 1304 transmits the multiplexed signal management information of the entire system stored in this management table, to the optical multiplexing apparatuses 1 to N (102). The optical multiplexing apparatuses 1 to N (102) receive and store the multiplexed signal management information. Thus, each of the optical multiplexing apparatuses 1 to N (102) can grasp the operating states of the other optical multiplexing apparatuses 102 and transmit a signal in an available frequency band.

For example, for management number 1 of FIG. 14, the signal insertion node on the optical transmission line 101 is A-2; the modulation frequency is 100 MHz; the occupied bandwidth is 200 MHz; the center frequency is 5900 MHz; and a modulation signal is in use. For management number 3, the signal insertion node on the optical transmission line 101 is A-1; the modulation frequency is 650 MHz; the occupied bandwidth is 1300+50 MHz; the center frequency is 9150 MHz; and a modulation signal is not in use. Accordingly, using the center frequencies corresponding to the management numbers indicating that a modulation signal is in use, the monitoring control unit 1301 controls the amount of dispersion of the variable chromatic dispersion medium X (1000). That is, the monitoring control unit 1301 searches the multiplexed signal management information 1401 in the management table for modulation signals having the lowest and highest frequencies f_{LOW} and f_{High}, respectively, of modulation signals in use.

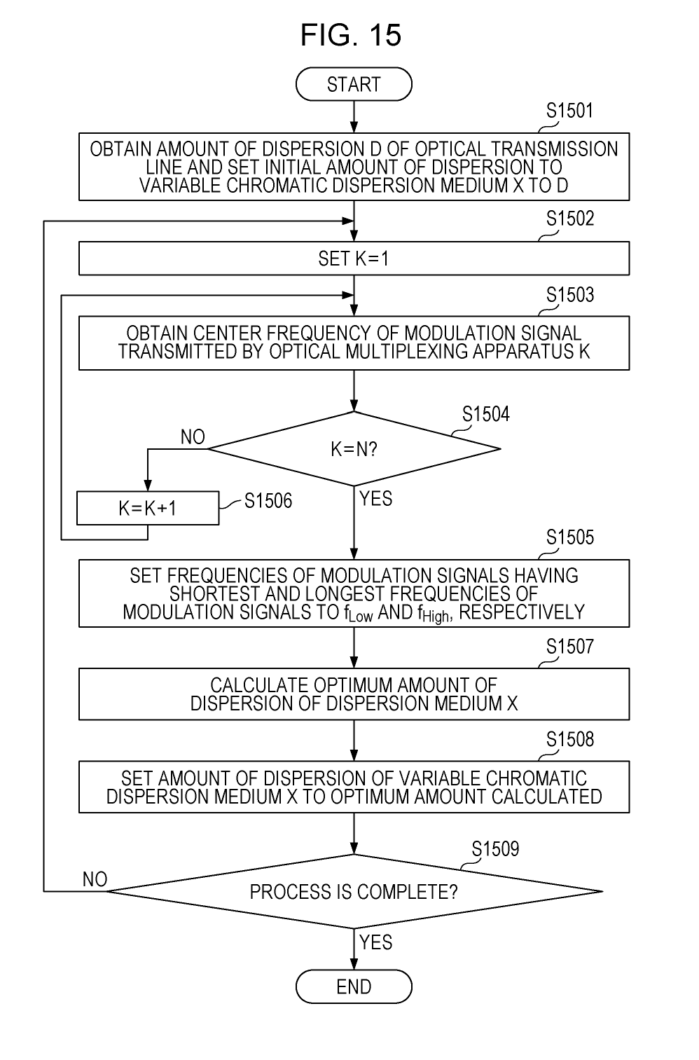

FIG. 15 is a flowchart illustrating a dispersion amount variable control process performed by the monitoring control unit illustrated in FIG. 13. First, the monitoring control unit 1301 obtains the amount of dispersion D of the optical transmission line 101 and sets the initial amount of dispersion of the variable chromatic dispersion medium X (1000) to the amount of dispersion D (operation S1501). The monitoring control unit 1301 then sets the number K of an optical multiplexing apparatus 102 to an initial value 1 (operation S1502). The monitoring control unit 1301 then obtains the center frequency of a modulation signal transmitted by the optical multiplexing apparatus K (102) (operation S1503). The center frequency is obtained by searching the management table illustrated in FIG. 14.

The monitoring control unit 1301 then determines whether K is N (operation S1504). N represents the number of all the optical multiplexing apparatuses 102 disposed on the optical transmission line 101 and is used to determine whether information about all the optical multiplexing apparatuses has been obtained by searching the management table. If K is not N (operation S1504: NO), the monitoring control unit 1301 increments K by 1 (operation S1506) and returns to operation S1503. If K is N (operation S1504: YES), the monitoring control unit 1301 proceeds to operation S1505.

In operation S1505, the monitoring control unit 1301 searches the management table for modulation signals having the lowest and highest frequencies and sets these frequencies to f_{LOW} and f_{High}, respectively (operation S1505). The monitoring control unit 1301 then calculates the optimum amount of dispersion using Formula (16) above (operation S1507). The monitoring control unit 1301 then sets the amount of dispersion of the variable chromatic dispersion medium X (1000) to the optimum amount calculated (operation S1508). The monitoring control unit 1301 then determines whether the process is complete (operation S1509). If a scan has to be performed (operation S1509: NO), the monitoring control unit 1301 returns to operation S1502; if a scan is complete (operation S1509: YES), it ends the process.

As described above, by using the multiplexed signal management information shared by all the optical multiplexing apparatuses 102, the monitoring control unit 1301 can grasp, in real time, the lower and upper limits of the current operating frequency band. Further, whenever a change is made to the frequency used by each optical multiplexing apparatus 102, the monitoring control unit 1301 can calculate the optimum amount of dispersion to control the amount of dispersion of the variable chromatic dispersion medium X (1000) in accordance with the frequency changed.

According to the embodiment described above, it is possible to transmit information from multiple optical multiplexing apparatuses on the optical transmission line using the optical FDM system. The optical multiplexing apparatuses superimpose sub-carrier modulation signals having different sub-carrier frequencies on a carrier wave. In the embodiment described above, the chromatic dispersion media are disposed in the receiving apparatuses, and the amounts of dispersion of the chromatic dispersion media are set to desirable amounts on the basis of the sub-carrier frequencies used by the optical multiplexing apparatuses. Thus, the receiving apparatuses can extract the sub-carrier modulation signals transmitted by the optical multiplexing apparatuses in such a manner that the sub-carrier modulation signals have good waveforms.

Further, since each receiving apparatus is configured to monitor the sub-carrier frequencies of the optical multiplexing apparatuses, it can perform variable control so that the amount of dispersion of the chromatic dispersion medium therein is usually optimized according to the frequencies used by the optical multiplexing apparatuses. Thus, even when the frequency used by each optical multiplexing apparatus is changed, the receiving apparatus can usually stably receive signals, as well as can improve reception quality.

The monitoring control circuit 1101 and the monitoring control unit 1301 described in the present embodiment can be achieved by execution of a previously prepared program by a processor, such as a CPU. This program can be recorded in a processor-readable recording medium and executed when the processor reads it from the recording medium. This program may be distributed via a network, such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An optical signal receiving apparatus disposed in an optical frequency-division-multiplexing transmission system in which a plurality of optical multiplexing apparatuses serving as nodes on an optical transmission line convert input signals into sub-carrier modulation signals having different sub-carrier frequencies, modulate a carrier optical signal using the sub-carrier modulation signals and transmit the carrier optical signal modulated, the optical signal receiving apparatus comprising:
a chromatic dispersion medium having an amount of chromatic dispersion which is determined according to a frequency of the sub-carrier modulation signals so as to receive the sub-carrier modulation signals;
a photodetector configured to convert the carrier optical signal that has passed through the chromatic dispersion medium, into electrical signals; and
a signal receiving unit configured to receive an electrical signal selected from the electrical signals obtained by the photodetector.

2. The optical signal receiving apparatus according to claim 1, wherein
the amount of dispersion of the chromatic dispersion medium is set to a value corresponding to a frequency such that degradation of amplitude in a frequency band of the sub-carrier modulation signals falls within a given range.

3. The optical signal receiving apparatus according to claim 2, wherein
the given range of the degradation of amplitude is 0 to −3 dB.

4. The optical signal receiving apparatus according to claim 1, wherein
the amount of dispersion of the chromatic dispersion medium is set to a value in a range which is allowable with respect to a frequency band of the sub-carrier modulation signals.

5. The optical signal receiving apparatus according to claim 1, wherein
a chromatic dispersion medium which adds positive dispersion is used as the chromatic dispersion medium.

6. The optical signal receiving apparatus according to claim 1, wherein
the amount of dispersion of the chromatic dispersion medium is set to a value except for an amount of dispersion of the optical transmission line.

7. The optical signal receiving apparatus according to claim 1, wherein
when the sub-carrier modulation signals are multiplexed, the amount of dispersion of the chromatic dispersion medium is set based on respective allowable ranges of upper-limit and lower limit frequencies of a frequency band of the sub-carrier modulation signals and based on an amount of dispersion of the optical transmission line.

8. The optical signal receiving apparatus according to claim 1, wherein
a variable chromatic dispersion medium having a variable amount of dispersion is used as the chromatic dispersion medium.

9. The optical signal receiving apparatus according to claim 8, wherein
the signal receiving unit comprises:
a filter configured to receive the electrical signal obtained by the photodetector and to allow the sub-carrier modulation signals in a desired frequency band to pass therethrough; and
a phase synchronization circuit configured to detect the sub-carrier modulation signals that have passed through the filter, by phase-synchronization, further comprising
a control circuit configured to control the amount of dispersion of the variable chromatic dispersion medium so that output amplitude of the phase synchronization circuit is maximized.

10. The optical signal receiving apparatus according to claim 8, wherein
the signal receiving unit comprises:
a filter configured to receive the electrical signal obtained by the photodetector and to allow the sub-carrier modulation signals in a desired frequency band to pass therethrough; and
a phase synchronization circuit configured to detect the sub-carrier modulation signals that have passed through the filter, by phase-synchronization, further comprising
an electrical spectrum analyzer configured to monitor a frequency characteristic of the electrical signal obtained by the photodetector and to identify a frequency band of the sub-carrier modulation signals in use; and
a monitoring control circuit configured to control the amount of dispersion of the variable chromatic dispersion medium based on respective allowable ranges of upper and lower limits of the frequency band of the sub-carrier modulation signals identified by the electrical spectrum analyzer and based on the amount of dispersion of the optical transmission line.

11. A method for receiving, by an optical signal receiving apparatus, the method comprising:
setting a value corresponding to a frequency of sub-carrier modulation signals to an amount of dispersion of a chromatic dispersion medium;
converting carrier optical signal that has passed through the chromatic dispersion medium, into electrical signals, the carrier optical signal being modulated by using the sub-carrier modulation signals; and
receiving an electrical signal selected from the electrical signals obtained by the photodetector.

12. The method for receiving an optical signal according to claim 11, wherein
the amount of dispersion of the chromatic dispersion medium is set to the value corresponding to the frequency such that degradation of amplitude in a frequency band of the sub-carrier modulation signals falls within a given range.

13. An optical frequency-division-multiplexing transmission system, comprising:
a plurality of optical multiplexing apparatuses serving as nodes on an optical transmission line and configured to convert input signals into sub-carrier modulation signals having different sub-carrier frequencies, to modulate a carrier optical signal using the sub-carrier modulation signals, and to transmit the carrier optical signal modulated; and
an optical signal receiving apparatus comprising:
a chromatic dispersion medium having a given amount which is set to a value corresponding to a frequency of the sub-carrier modulation signals;
a photodetector configured to convert the carrier optical signal that has passed through the chromatic dispersion medium, into electrical signals; and
a signal receiving unit configured to receive an electrical signal selected from the electrical signals obtained by the photodetector.

14. The optical frequency-division-multiplexing transmission system according to claim 13, wherein
the optical multiplexing apparatus serving as a node and having a longer transmission distance from the optical signal receiving apparatus uses a sub-carrier modulation signal having a lower frequency, of the sub-carrier modulation signals, and the optical multiplexing apparatus serving as a node and having a shorter transmission distance from the optical signal receiving apparatus uses a sub-carrier modulation signal having a higher frequency, of the sub-carrier modulation signals.

15. The optical frequency-division-multiplexing transmission system according to claim 13, wherein
the optical signal receiving apparatus comprises a plurality of optical signal receiving apparatuses, and
the chromatic dispersion media of the optical signal receiving apparatuses have amounts of dispersion having different tolerance bands with respect to the sub-carrier modulation signals so that the optical signal receiving apparatuses receive the sub-carrier modulation signals in a wide band.

16. The optical frequency-division-multiplexing transmission system according to claim 13, wherein
the optical signal receiving apparatus comprises a plurality of optical signal receiving apparatuses, and
the plurality of chromatic dispersion media are cascade-connected and a junction of the chromatic dispersion media is connected to the optical signal receiving apparatuses via an optical demultiplexer so that the optical signal receiving apparatuses receive the sub-carrier modulation signals in a wide band.

17. The optical frequency-division-multiplexing transmission system according to claim 13, wherein
the optical receiving apparatus further comprises:
a variable chromatic dispersion medium serving as the chromatic dispersion medium and having a variable amount of dispersion; and
a monitoring control unit configured to manage, as multiplexed information management information, use states of the sub-carrier modulation signals transmitted by the optical multiplexing apparatuses, and
the monitoring control unit controls the amount of dispersion of the variable chromatic dispersion medium based on respective allowable ranges of upper-limit and lower-limit frequencies of a frequency band of the sub-carrier modulation signals and based on an amount of dispersion of the optical transmission line.

18. The optical frequency-division-multiplexing transmission system according to claim 17, wherein
the multiplexed signal management information includes pieces of information indicating occupied bandwidths, center frequencies, and empty frequency states of the sub-carrier modulation signals transmitted by the optical multiplexing apparatuses.

19. The optical frequency-division-multiplexing transmission system according to claim 17, wherein
the optical receiving apparatus further comprises a downlink signal generation unit configured to transmit the multiplexed signal management information managed by the monitoring control unit to the optical multiplexing apparatus.
